(19) United States
(12) Patent Application Publication
(10) Pub. No.: US 2023/0420711 A1
(43) Pub. Date: Dec. 28, 2023

(54) FUEL CELL SYSTEM

(71) Applicant: DENSO CORPORATION, Kariya-city (JP)

(72) Inventor: Takashi YAMADA, Kariya-city (JP)

(21) Appl. No.: 18/465,222

(22) Filed: Sep. 12, 2023

Related U.S. Application Data
(63) Continuation of application No. PCT/JP2022/006627, filed on Feb. 18, 2022.

(30) Foreign Application Priority Data
Mar. 16, 2021 (JP) 2021-042657

(51) Int. Cl. H01M 8/04746; H01M 8/04537; H01M 8/0432

(52) U.S. Cl. CPC H01M 8/04753; H01M 8/04559; H01M 8/04649; H01M 8/04589; H01M 8/0432

(57) ABSTRACT

A fuel cell system includes a fuel cell stack including a plurality of single cells stacked, a dry-wet detection unit that detects a dry-wet state of the fuel cell stack, and an operation control unit that controls operation of the fuel cell stack. When an operating condition under which the fuel cell stack is at a high temperature and at a high load is established, the dry-wet detection unit determines whether the fuel cell stack is in a deviation state of deviating from an ideal dry-wet state based on a physical quantity having a higher correlation with drying and wetting of the fuel cell stack than the temperature of the fuel cell stack. When the deviation state is detected, the operation control unit performs a reset operation for recovering the dry-wet state.

### CROSS REFERENCE TO RELATED APPLICATION

The present application is a continuation application of International Patent Application No. PCT/JP2022/006627 filed on Feb. 18, 2022, which designated the U.S. and claims the benefit of priority from Japanese Patent Application No. 2021-042657 filed on Mar. 16, 2021. The entire disclosures of all of the above applications are incorporated herein by reference.

### TECHNICAL FIELD

The present disclosure relates to a fuel cell system including a fuel cell stack in which a plurality of single cells are stacked.

### BACKGROUND

Conventionally, a fuel cell stack has been used to generate an electric current by causing an electrochemical reaction between hydrogen and oxygen.

### SUMMARY

According to an aspect of the present disclosure, a fuel cell system comprises a fuel cell stack including a plurality of single cells being stacked.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic configuration diagram of a fuel cell system according to a first embodiment;

FIG. 2 is a schematic block diagram showing a control apparatus of the fuel cell system;

FIG. 3 is a flowchart showing an example of control processing executed by the control apparatus of the first embodiment;

FIG. 4 is a flowchart showing an example of drying diagnosis processing executed by the control apparatus of the first embodiment;

FIG. 5 is a flowchart showing an example of reset processing executed by the control apparatus of the first embodiment;

FIG. 6 is a flowchart showing an example of recovery diagnosis processing executed by the control apparatus of the first embodiment;

FIG. 7 is a timing chart for illustrating an operation of the fuel cell system according to the first embodiment;

FIG. 8 is a timing chart for illustrating an operation of a fuel cell system as a first comparative example of the first embodiment;

FIG. 9 is a timing chart for illustrating an operation of a fuel cell system as a second comparative example of the first embodiment;

FIG. 10 is a flowchart showing an example of reset processing executed by a control apparatus of a second embodiment;

FIG. 11 is a flowchart showing an example of reset processing executed by a control apparatus of a third embodiment;

FIG. 12 is a flowchart showing an example of reset processing executed by a control apparatus of a fourth embodiment;

FIG. 13 is a flowchart showing an example of reset processing executed by a control apparatus of a fifth embodiment;

FIG. 14 is a flowchart showing an example of reset processing executed by a control apparatus of a sixth embodiment;

FIG. 15 is a flowchart showing an example of reset processing executed by a control apparatus of a seventh embodiment;

FIG. 16 is a flowchart showing an example of drying diagnosis processing executed by a control apparatus of an eighth embodiment; and

FIG. 17 is a flowchart showing an example of recovery diagnosis processing executed by the control apparatus of the eighth embodiment.

### DETAILED DESCRIPTION

Hereinafter, examples of the present disclosure will be described.

According to an example of the present disclosure, a device is employed in a fuel stack. The device controls, in order to suppress drying of the fuel cell stack, a back pressure regulating valve so that a back pressure of a cathode gas increases when a temperature of the fuel cell stack exceeds a predetermined reference temperature.

However, the drying of the fuel cell stack appears later than the temperature change of the fuel cell stack. For this reason, when the back pressure of the cathode gas is regulated according to the temperature of the fuel cell stack as in the conventional technique, drying of the fuel cell stack is suppressed in a state where the fuel cell stack is not dried, and the performance of the system is decreased. This was found through intensive studies by the present inventors.

According to an example of the present disclosure, a fuel cell system comprises: a fuel cell stack including a plurality of single cells being stacked; a dry-wet detection unit configured to detect a dry-wet state of the fuel cell stack; and an operation control unit configured to control an operation of the fuel cell stack. The dry-wet detection unit is configured to, when an operating condition in which the fuel cell stack is at a high temperature and at a high load is established, determine whether the fuel cell stack is in a deviation state, which deviates from an ideal dry-wet state, based on a physical quantity, wherein the physical quantity has a higher correlation with drying and wetting of the fuel cell stack than a temperature of the fuel cell stack. The operation control unit is configured to perform, on detection of the deviation state, a reset operation to recover the dry-wet state.

The drying of the fuel cell stack tends to occur when the fuel cell stack is at a high temperature and applied with a high load. That is, when the operating condition, under which the fuel cell stack is at a high temperature and applied with a high load, is established, the fuel cell stack is likely to deviate from the ideal dry-wet state. Therefore, it is desirable to determine the dry-wet state of the fuel cell stack when an operating condition under which the fuel cell stack is at a high temperature and at a high load is established. According to this, it is possible to accurately detect whether the dry-wet state of the fuel cell stack is in the deviation state. In addition, since the dry-wet state of the fuel cell stack is determined based on a physical quantity having a higher correlation with drying and wetting of the fuel cell stack than the temperature of the fuel cell stack, the dry-wet state of the fuel cell stack can be accurately detected as compared with the case where the dry-wet state is determined based on the temperature of the fuel cell stack. Accordingly, the reset operation can be performed at an appropriate timing. Therefore, the dry-wet state of the fuel cell stack can accurately be detected, and the performance of the system can be improved.

Hereinafter, embodiments of the present disclosure will be described with reference to the drawings. In the following embodiments, the same or equivalent elements as those described in a preceding embodiment are denoted by the same reference numerals, and the description thereof may be omitted. In addition, in an embodiment, when only some of the components are described, the components described in the preceding embodiment can be applied to the other parts of the components. In the following embodiments, the respective embodiments can be partially combined with each other even if not particularly explicitly specified as long as within the range where the combination is not particularly hindered.

### First Embodiment

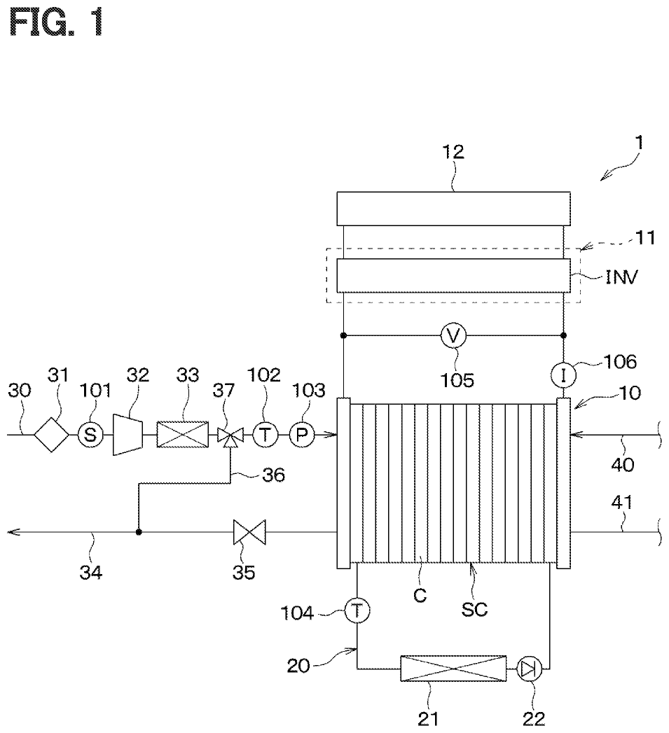

The present embodiment will be described with reference to FIGS. 1 to 9. In the present embodiment, an example will be described in which the fuel cell system 1 of the present disclosure is adapted to a vehicle FCV that obtains electric power to be supplied to a motor for vehicle traveling by a fuel cell stack 10. FCV is an abbreviation for fuel cell vehicle.

The fuel cell system 1 includes a fuel cell stack 10 that generates electric power using an electrochemical reaction between hydrogen and oxygen. The fuel cell stack 10 supplies power to a power conversion apparatus 11 such as an inverter INV. The inverter INV converts a direct current supplied from the fuel cell stack 10 into an alternating current and supplies the alternating current to the load apparatus 12 such as a traveling motor to drive the load apparatus 12.

Although not shown, a power storage apparatus that stores electric power is connected to the fuel cell stack 10. The fuel cell system 1 is configured so that power to be surplus in power output from the fuel cell stack 10 is accumulated in the power storage apparatus.

The fuel cell stack 10 is configured as a cell stack CS in which a plurality of single cells C serving as minimum units are stacked. The single cell C has a cell surface spreading in a direction orthogonal to the stacking direction of the single cell C. The power generation surface contributing to power generation on the cell surface of the single cell C corresponds to “a plane of a single cell C”.

The single cell C includes a solid polymer electrolyte cell (what is called, PEFC) including an electrolyte membrane, a catalyst, a gas diffusion layer, and a separator. In the single cell C, an electrolyte membrane is sandwiched between a catalyst, a gas diffusion layer, and a separator. In the single cell C, when hydrogen is supplied to the anode electrode side and oxygen is supplied to the cathode electrode side, an electrochemical reaction represented by the following reaction formulas F1 and F2 occurs to generate electric energy.

Anode electrode side:H₂→2H⁺+2e⁻ (F1)

Cathode electrode side:2H⁺+½O₂+2e⁻→H₂O (F2)

For the electrochemical reaction to occur, the electrolyte membrane of the single cell C needs to be in a wet state containing water. The fuel cell system 1 humidifies an electrolyte membrane inside the fuel cell stack 10. The humidification of the electrolyte membrane can be achieved by disposing a humidification device or the like in a supply path of hydrogen, which is a fuel gas, or air, which is an oxidant gas.

The fuel cell stack 10 generates heat by the electrochemical reaction. The operating temperature of the fuel cell stack 10 needs to be maintained at about 80° C. in relation to improvement in power generation efficiency, suppression of deterioration of the electrolyte membrane, and the like.

The fuel cell system 1 includes a cooling water circuit 20 for adjusting the temperature of the fuel cell stack 10 to an appropriate temperature. The cooling water circuit 20 is provided with a radiator 21 and a water pump 22. The radiator 21 is a radiator that exchanges heat of cooling water raised in temperature by heat of the fuel cell stack 10 with outside air to dissipate heat.

The fuel cell system 1 is provided with an air supply path 30 for supplying air containing oxygen toward the fuel cell stack 10. In the air supply path 30, an air filter 31 is provided at the most upstream portion, and an air pump 32 is provided downstream of the air filter 31. The air pump 32 constitutes an oxidant gas supply unit that supplies an oxidant gas to the fuel cell stack 10. In the air pump 32, the supply capacity of air to the fuel cell stack 10 is controlled based on a control signal from the control apparatus 100 described below.

An intercooler 33 is disposed between the air pump 32 and the fuel cell stack 10. The intercooler 33 cools the air pressurized by the air pump 32 by causing the air to be heat-exchanged with the off-gas or the cooling water of the fuel cell stack 10.

The fuel cell system 1 is provided with an air discharge path 34 for flowing the off-gas (that is, off-air) of air to be discharged from the fuel cell stack 10 to a muffler not shown. The air discharge path 34 is provided with an air valve 35. The air valve 35 is a regulating valve that regulates air pressure inside the fuel cell stack 10. The fuel cell system 1 is provided with a bypass path 36 that bypasses the fuel cell stack 10 to allow a part of air flowing through the air supply path 30 to flow through the air discharge path 34. The bypass path 36 is provided to reduce the hydrogen concentration in the off-fuel to be exhausted from the muffler through a hydrogen discharge path described below.

The bypass path 36 has one end side connected between the intercooler 33 in the air supply path 30 and the fuel cell stack 10, and has the other end side connected to the downstream side of the air valve 35 in the air discharge path 34. The bypass path 36 is provided with a three-way valve 37 at a connection portion with the air supply path 30. The three-way valve 37 is a flow rate regulating valve that regulates the flow rate of the air flowing through the bypass path 36.

The fuel cell system 1 is provided with a hydrogen supply path 40 for supplying hydrogen toward the fuel cell stack 10. Although not shown, the hydrogen supply path 40 is provided with a high-pressure hydrogen tank at the most upstream portion, and is provided with a fuel valve downstream of the high-pressure hydrogen tank.

The fuel cell system 1 is provided with a hydrogen discharge path 41 for flowing the off-gas (that is, off-fuel) of hydrogen to be discharged from the fuel cell stack 10 to a muffler not shown. Although not shown, the hydrogen discharge path 41 is provided with an exhaust valve. The downstream side of the hydrogen discharge path 41 is connected to the air discharge path 34. Accordingly, the off-fuel flowing through the hydrogen discharge path 41 is mixed with the off-air, diluted, and then exhausted from the muffler.

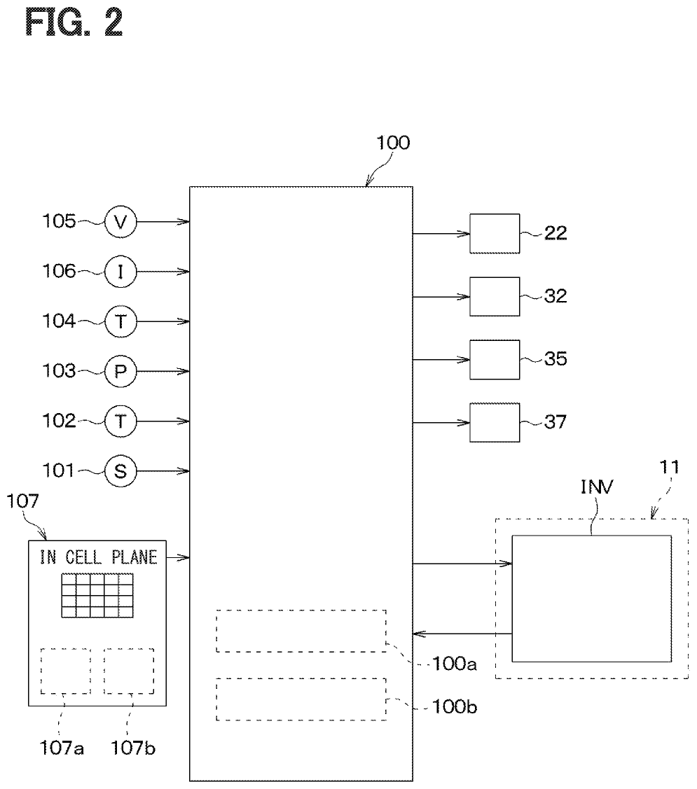

Next, an electronic control unit of the fuel cell system 1 will be described with reference to FIG. 2. As shown in FIG. 2, the fuel cell system 1 includes a control apparatus 100. The control apparatus 100 controls operations of various control target apparatuses constituting the fuel cell system 1. The control apparatus 100 includes a microcomputer including a processor and a memory, and peripheral circuits thereof. The memory of the control apparatus 100 is a non-transitory tangible storage medium.

The control apparatus 100 has an input side thereof connected with an air flow meter 101, an air temperature sensor 102, an air pressure sensor 103, a water temperature sensor 104, an FC voltage detection unit 105, an FC current detection unit 106, an impedance detection unit 107, and the like.

The air flow meter 101, the air temperature sensor 102, and the air pressure sensor 103 are disposed in the air supply path 30. The air flow meter 101 is a sensor that detects the flow rate of the air flowing through the air supply path 30. The air temperature sensor 102 is a sensor that detects the temperature of the air flowing through the air supply path 30. The air pressure sensor 103 is a sensor that detects the pressure of the air flowing through the air supply path 30. A detection value of the air pressure sensor 103 corresponds to a pressure (that is, the air pressure) of the air inside the fuel cell stack 10.

The water temperature sensor 104 is provided in the cooling water circuit 20. The water temperature sensor 104 is a sensor that detects the temperature of the cooling water immediately after passing through the fuel cell stack 10. The detection value of the water temperature sensor 104 corresponds to the temperature (that is, FC temperature) of the fuel cell stack 10.

The FC voltage detection unit 105 and the FC current detection unit 106 are provided in a connection line between the fuel cell stack 10 and the inverter INV. The FC voltage detection unit 105 is a sensor that detects an output voltage (that is, FC voltage) output from the fuel cell stack 10. The FC current detection unit 106 is a sensor that detects a current flowing through the fuel cell stack 10.

Here, when the fuel cell stack 10 is dried, since the membrane resistance of the electrolyte membrane of the single cell C increases, the output voltage of the fuel cell stack 10 decreases. As described above, there is a strong correlation between the water content inside the fuel cell stack 10 and the output voltage of the fuel cell stack 10. That is, the output voltage of the fuel cell stack 10 is a physical quantity having a higher correlation with drying and wetting of the fuel cell stack 10 than the temperature of the fuel cell stack 10.

The impedance detection unit 107 is a device that detects impedance imp of the fuel cell stack 10. The impedance detection unit 107 includes an AC superposition unit 107a that superposes an AC signal at a predetermined frequency on the output current of the fuel cell stack 10 and an arithmetic unit 107b that calculates an impedance imp from the output current on which the AC signal is superposed.

Here, when the fuel cell stack 10 is dried, since the membrane resistance of the electrolyte membrane of the single cell C increases, the impedance imp of the fuel cell stack 10 increases. That is, the impedance imp of the fuel cell stack 10 is a physical quantity having a higher correlation with drying of the fuel cell stack 10 than the temperature of the fuel cell stack 10. In particular, the impedance imp when an AC signal at a high frequency of 500 Hz or more is superposed has a strong correlation with the membrane resistance of the electrolyte membrane of the single cell C. By taking into account of these, the impedance detection unit 107 of the present embodiment detects the impedance imp when a high-frequency AC signal is superposed as a physical quantity having a higher correlation with the drying and wetting of the fuel cell stack 10 than the temperature of the fuel cell stack 10.

The impedance detection unit 107 is configured to be able to grasp the distribution of the impedance imp in the plane of the single cell C. For example, the impedance detection unit 107 can grasp the impedance imp of each of the air inlet region, the air outlet region, and the intermediate region in the plane of the single cell C. Accordingly, the impedance detection unit 107 can detect the impedance imp at a specific place in the plane of the single cell C. The specific place is, for example, a site on the air inlet side of the air flow path where drying is particularly likely to occur in the plane of the single cell C. On the air inlet side of the single cell C, drying is likely to occur because water is swept away downstream together with air supplied to the fuel cell stack 10.

The control apparatus 100 of the present embodiment detects the dry-wet state of the fuel cell stack 10 based on the detection value of the impedance detection unit 107. In the present embodiment, in the control apparatus 100, a portion that exhibits a function of detecting a dry-wet state of the fuel cell stack 10 constitutes the dry-wet detection unit 100a.

Control target apparatuses such as a water pump 22, an air pump 32, an air valve 35, a three-way valve 37, and a fuel valve (not shown) are connected to an output side of the control apparatus 100. In addition, a power conversion apparatus 11 such as an inverter INV is connected to the control apparatus 100. The control apparatus 100 causes the control target apparatus connected to the output side to operate based on the control program stored in the memory to control the operation of the fuel cell stack 10. The control apparatus 100 of the present embodiment constitutes an operation control unit 100b that controls the operation of the fuel cell stack 10.

In the fuel cell system 1 configured as described above, in order that the power corresponding to the required power from the load apparatus 12 such as the traveling motor is output, the operation of the control target apparatus connected to the output side is controlled by the control apparatus 100.

When the required power for the fuel cell stack 10 is small, the control apparatus 100 controls the capacity of the air pump 32 and the opening degree of the fuel valve so that the supply amount of hydrogen and air to the fuel cell stack 10 decreases.

On the other hand, when the required power for the fuel cell stack 10 is large, the control apparatus 100 controls the capacity of the air pump 32 and the opening degree of the fuel valve so that the supply amount of hydrogen and air to the fuel cell stack 10 increases.

When the required power for the fuel cell stack 10 is large, the current flowing through the fuel cell stack 10 increases, and the fuel cell stack 10 becomes a high load. In addition, since the calorific value of the fuel cell stack 10 increases, the fuel cell stack 10 is at a high temperature. When such an operation state is continued, the fuel cell stack 10 easily dries. Therefore, in order to suppress drying of the fuel cell stack 10, it is conceivable to perform treatment of suppressing drying when the temperature of the fuel cell stack 10 exceeds a predetermined reference temperature.

However, the drying of the fuel cell stack 10 appears later than the temperature change of the fuel cell stack 10. For this reason, as described above, when the treatment of suppressing the drying is performed according to the temperature of the fuel cell stack 10, the drying of the fuel cell stack 10 is suppressed in a state where the fuel cell stack 10 is not dried, and the performance of the system is deteriorated.

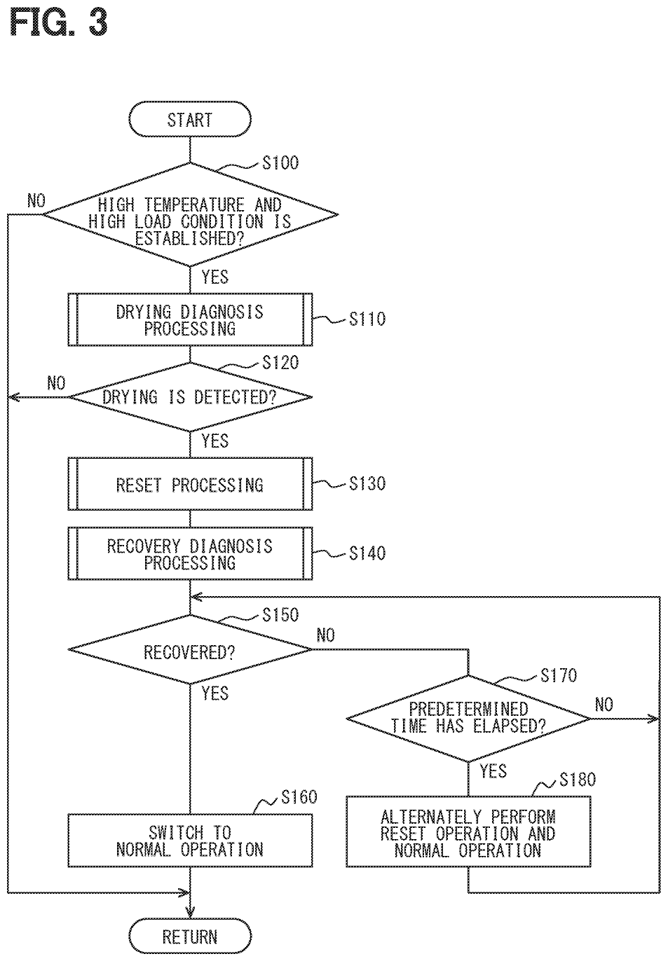

In consideration of these, the control apparatus 100 of the present embodiment detects whether the fuel cell stack 10 is in a deviation state of deviating from the ideal dry-wet state using the physical quantity having a higher correlation with the drying and wetting of the fuel cell stack 10 than the temperature of the fuel cell stack 10. The deviation state includes not only a dry state in which the electrolyte membrane is dried but also an excessively wet state in which the electrolyte membrane is excessively wet. Hereinafter, the control processing executed by the control apparatus 100 of the present embodiment will be described with reference to FIGS. 3, 4, 5, and 6. The control processing shown in FIG. 3 is executed by the control apparatus 100 periodically or irregularly after the start of the fuel cell stack 10.

As shown in FIG. 3, the control apparatus 100 determines whether the high-temperature and high-load condition is established in step S100. The high-temperature and high-load condition is an operating condition under which the fuel cell stack 10 is at a high temperature and at a high load. That is, the high-temperature and high-load condition is a condition that is established when the current flowing through the fuel cell stack 10 becomes equal to or higher than a reference current and when the temperature of the fuel cell stack 10 becomes equal to or higher than a reference temperature.

When the high-temperature and high-load condition is established, the fuel cell stack 10 is in a situation of being likely to dry. Therefore, when the high-temperature and high-load condition is established, the control apparatus 100 proceeds to the drying diagnosis processing in step S110. On the other hand, when the high-temperature and high-load condition is not established, the control apparatus 100 skips the subsequent processing and exits the present control processing.

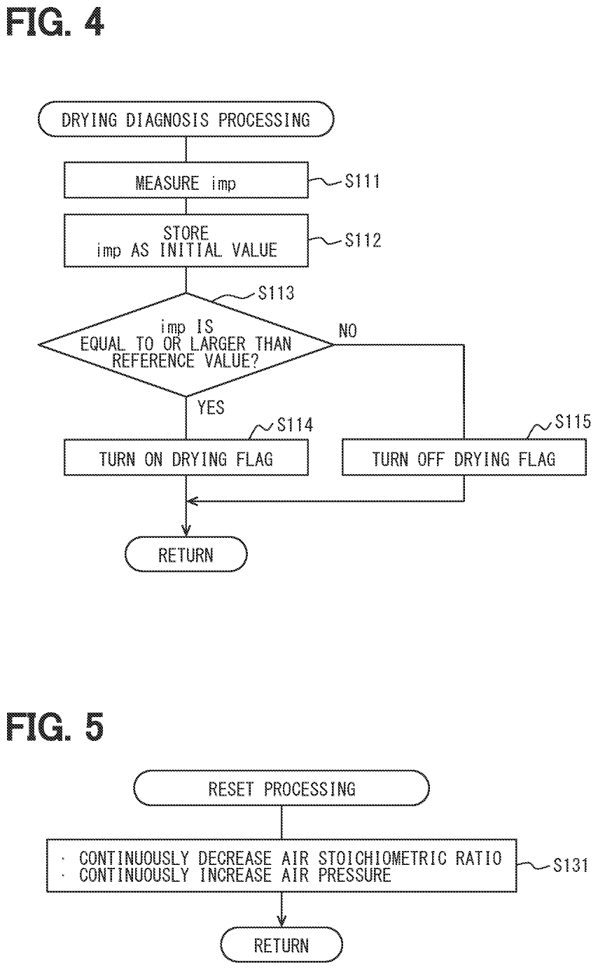

In the drying diagnosis processing, it is determined whether the fuel cell stack 10 is in the deviation state of deviating from the ideal dry-wet state based on the change amount of the impedance imp. Hereinafter, the drying diagnosis processing executed by the control apparatus 100 will be described with reference to the flowchart in FIG. 4.

As shown in FIG. 4, the control apparatus 100 measures the impedance imp of the fuel cell stack 10 in step S111. Specifically, the control apparatus 100 outputs a request signal for requesting the detection of impedance imp to the impedance detection unit 107. Accordingly, when receiving the request signal from the control apparatus 100, the impedance detection unit 107 calculates the impedance imp of the fuel cell stack 10 based on the output current of the fuel cell stack 10 on which the AC signal at the predetermined frequency is superposed. The control apparatus 100 acquires the impedance imp of the fuel cell stack 10 from the impedance detection unit 107.

Subsequently, in step S112, the control apparatus 100 stores the impedance imp when the high-temperature and high-load condition is first established after the start of the fuel cell stack 10 in the memory as an initial value. The initial value may be a fixed value, but may be learned and updated based on the impedance imp when the high-temperature and high-load condition is established in the next and subsequent times. For example, the initial value may be an average value of the impedances imp when the high-temperature and high-load condition is established.

Subsequently, the control apparatus 100 determines whether the fuel cell stack 10 is in the deviation state of deviating from the ideal dry-wet state. Specifically, in step S113, the control apparatus 100 determines whether the impedance imp is equal to or larger than a reference value. The reference value is set to, for example, an impedance imp actually measured in a state where the fuel cell stack 10 is dried or an impedance imp in a state where the water content inside the fuel cell stack 10 is equal to or less than a predetermined value.

When the impedance imp is equal to or larger than the reference value, it is estimated that the fuel cell stack 10 is dried. Therefore, the control apparatus 100 determines that the fuel cell stack 10 is in the deviation state of deviating from the ideal dry-wet state. Specifically, the control apparatus 100 turns on the drying flag in step S114. The drying flag is a flag indicating a dry-wet state of the fuel cell stack 10, and is turned on by the control apparatus 100 when the drying of the fuel cell stack 10 is detected.

On the other hand, when the impedance imp is less than the reference value, it is estimated that the fuel cell stack 10 is not dried. Therefore, the control apparatus 100 turns off the drying flag in step S115.

The drying diagnosis processing has been described so far. When the drying diagnosis processing in step S110 in FIG. 3 is completed, the control apparatus 100 proceeds to step S120 and determines whether drying of the fuel cell stack 10 is detected in the drying diagnosis processing. This determination is made based on the state of the drying flag.

When the drying of the fuel cell stack 10 is detected, the control apparatus 100 proceeds to the reset processing in step S130. When the drying of the fuel cell stack 10 is not detected, the control apparatus 100 skips the subsequent processing, and exits the present control processing.

The reset processing is processing of performing a reset operation for recovering a dry-wet state of the fuel cell stack 10 to an ideal state. The reset operation is an operation mode for bringing the dry-wet state of the fuel cell stack 10 close to the ideal dry-wet state from the deviation state of deviating from the ideal dry-wet state. For example, when the electrolyte membrane is in a dry state in which the electrolyte membrane is dried, the reset operation is an operation in which the dry state is reset to an appropriate wet state, or the state is brought close to an excessively wet state in which the electrolyte membrane is excessively wet from the dry state. Hereinafter, the reset processing executed by the control apparatus 100 will be described with reference to the flowchart in FIG. 5.

As shown in FIG. 5, the control apparatus 100 decreases the air stoichiometric ratio and increases the air pressure in step S131. The control apparatus 100 continuously decreases the air stoichiometric ratio and continuously increases the air pressure. The reset operation is a gradual change operation in which the air stoichiometric ratio and the air pressure are gradually changed. In the reset operation of the present embodiment, a decrease in the air stoichiometric ratio and an increase in the air pressure are started at the same timing by the control apparatus 100.

Here, the air stoichiometric ratio is a ratio of the amount of oxidant gas supplied to the fuel cell stack 10 to the amount of oxidant gas theoretically required for power generation by the fuel cell stack 10. The air stoichiometric ratio can be calculated based on the amount of oxidant gas theoretically required for power generation by the fuel cell stack 10 and the flow rate of air detected by the air flow meter 101. In addition, the air pressure is the pressure of the oxidant gas inside the fuel cell stack 10. The air pressure can be detected by the air pressure sensor 103.

Specifically, the control apparatus 100 reduces the air stoichiometric ratio by gradually reducing the air supply capacity (for example, the rotation speed) of the air pump 32. When the air stoichiometric ratio decreases, since the amount by which water vapor on the air inlet side of the fuel cell stack 10 is swept away to the downstream side decreases, drying of the fuel cell stack 10 is suppressed.

In addition, the control apparatus 100 gradually increases the air pressure by reducing the opening degree of the air valve 35. When the air pressure increases, since the saturated water vapor pressure inside the fuel cell stack 10 increases, and the saturated water vapor amount increases, drying of the fuel cell stack 10 is suppressed.

This is the reset processing. When the reset processing in step S130 in FIG. 3 is completed, the control apparatus 100 proceeds to step S140 and executes the recovery diagnosis processing.

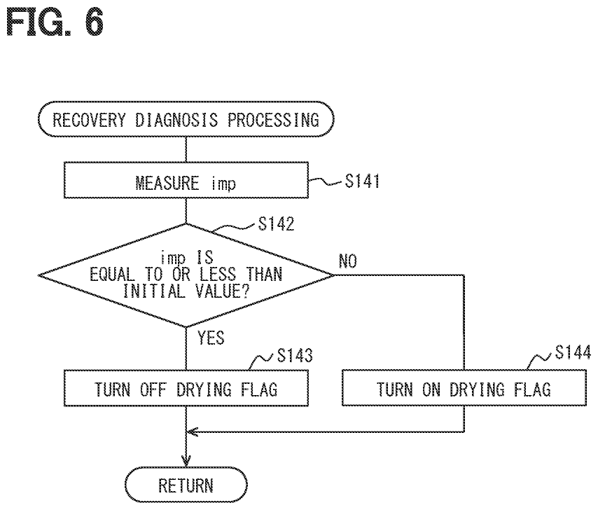

The recovery diagnosis processing is processing of diagnosing success or failure of a recovery condition for determining whether the drying of the fuel cell stack is recovered after the reset operation for recovering the drying of the fuel cell stack is performed. Hereinafter, the recovery diagnosis processing executed by the control apparatus 100 will be described with reference to the flowchart in FIG. 6.

As shown in FIG. 6, the control apparatus 100 measures the impedance imp of the fuel cell stack 10 in step S141. Since the processing is processing similar to that in step S111 in FIG. 4, the description thereof will be omitted.

Subsequently, in step S142, the control apparatus 100 determines whether the impedance imp is equal to or less than an initial value. The initial value is the impedance imp when the high-temperature and high-load condition is established.

When the impedance imp is equal to or less than the initial value, the impedance imp decreases to that at the time when the high-temperature and high-load condition is established, and it is estimated that the drying of the fuel cell stack 10 is sufficiently recovered by the reset processing. Therefore, when the impedance imp is equal to or less than the initial value, the control apparatus 100 turns off the drying flag in step S143.

On the other hand, when the impedance imp exceeds the initial value, it is estimated that the fuel cell stack 10 is still dried. Therefore, the control apparatus 100 keeps the drying flag on in step S144.

The recovery diagnosis processing has been described so far. When the recovery diagnosis processing in step S140 in FIG. 3 is completed, the control apparatus 100 proceeds to step S150 and determines whether the recovery of drying of the fuel cell stack 10 is detected in the recovery diagnosis processing. This determination is made based on the state of the drying flag.

When the recovery of drying of the fuel cell stack 10 is detected, in step S160, the control apparatus 100 switches the operation mode of the fuel cell stack 10 from the reset operation including the reset processing to the normal operation before performing the reset operation. In the normal operation, the operation of the control target apparatus connected to the output side of the fuel cell stack 10 is controlled by the control apparatus 100 in order that the power corresponding to the required power from the load apparatus 12 is output.

On the other hand, when the recovery of drying of the fuel cell stack 10 is not detected, the control apparatus 100 determines whether a predetermined time elapses from the start of the reset processing in step S170. The predetermined time is set to, for example, a time required from the start of the reset processing until the drying of the fuel cell stack 10 is recovered.

The control apparatus 100 repeats the determination in step S150 until the predetermined time elapses from the start of the reset processing. When the predetermined time elapses from the start of the reset processing, the control apparatus 100 proceeds to step S180.

In step S180, the control apparatus 100 performs processing of alternately repeating the reset operation, and the normal operation before the reset operation is performed, and proceeds to step S150. In the processing in step S180, for example, when one operation of the reset operation and the normal operation is performed for a predetermined reference time, the operation is switched to the other operation.

Here, FIG. 7 is an explanatory diagram for illustrating an operation of the fuel cell stack 10 at a high temperature and at a high load. As shown in FIG. 7, when the output of the fuel cell stack 10 increases and the temperature of the fuel cell stack 10 increases, the high-temperature and high-load condition is established.

At a stage where the high-temperature and high-load condition is established, the water distribution in the plane of the single cell C is uniform. In FIG. 7, a place having a large amount of water in the plane of the single cell C is highlighted with a dot pattern.

When a high temperature and high load state of the fuel cell stack 10 is continued, the single cell C starts to dry. Specifically, the moisture amount on the air inlet side in the plane of the single cell C decreases and starts to dry. In accordance with this, the impedance imp of the fuel cell stack 10 increases, and the output voltage of the fuel cell stack 10 decreases.

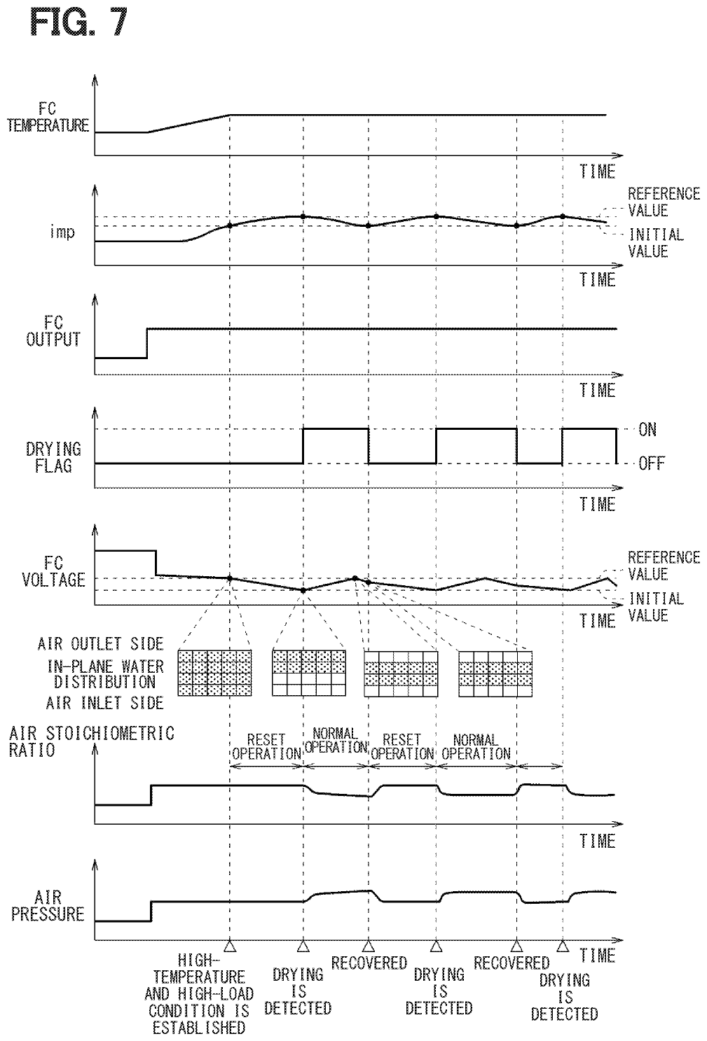

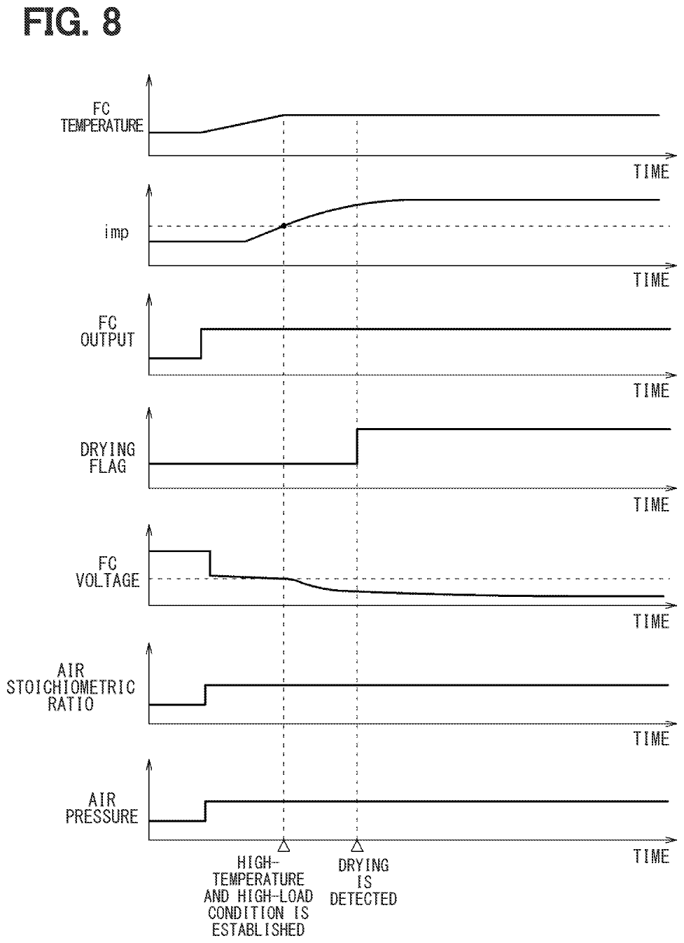

At this time, as shown in the first comparative example in FIG. 8, when the reset operation is not performed, the drying in the plane of the single cell C expands, the impedance imp of the fuel cell stack 10 increases, and the output voltage (that is, the FC voltage) of the fuel cell stack 10 decreases.

On the other hand, in the fuel cell system 1 of the present embodiment, when the impedance imp of the fuel cell stack 10 increases to the reference value, the drying flag is turned on, and the reset operation is started. Specifically, the control apparatus 100 decreases the air stoichiometric ratio and increases the air pressure. Accordingly, since the moisture on the air inlet side in the plane of the single cell C gradually increases and the drying in the plane of the single cell C starts to recover, the impedance imp of the fuel cell stack 10 decreases and the output voltage (that is, the FC voltage) of the fuel cell stack 10 increases.

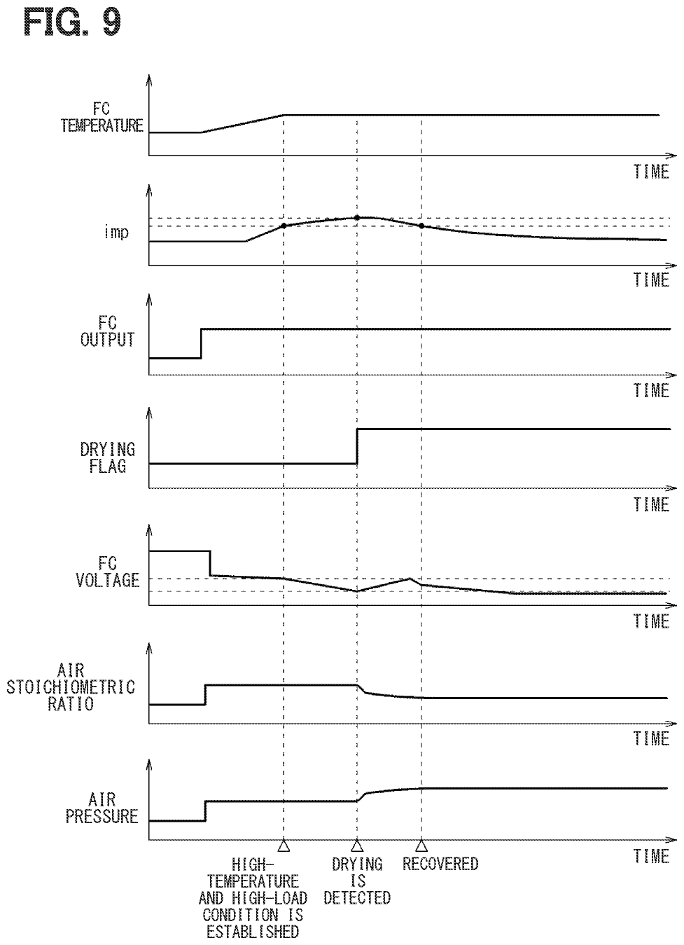

However, as shown in the second comparative example in FIG. 9, when the reset operation is continued for a long time, since drying occurs at another place such as the air outlet side or moisture on the air inlet side becomes excessive, the effect of the reset operation is reduced, and it becomes difficult to recover the fuel cell stack 10 as intended.

On the other hand, in the fuel cell system 1 of the present embodiment, when the impedance imp of the fuel cell stack 10 decreases to the initial value, the drying flag is turned off, and the operation is switched to the normal operation. According to this, since occurrence of drying at another place such as the air outlet side or excessive moisture on the air inlet side is suppressed, it is possible to appropriately obtain the effect of the reset operation.

When operating conditions under which the fuel cell stack 10 is at a high temperature and at a high load are established, the fuel cell system 1 described above determines whether the fuel cell stack 10 deviates from an ideal dry-wet state based on a physical quantity having a higher correlation with drying and wetting of the fuel cell stack 10 than a temperature of the fuel cell stack 10. When the deviation from the ideal dry-wet state is detected, the reset operation for recovering the dry-wet state of the fuel cell stack 10 to the ideal state is performed. According to this, the dry-wet state of the fuel cell stack 10 can accurately be detected as compared with the case where whether the fuel cell stack 10 is dried is determined based on the temperature of the fuel cell stack 10. In addition, the reset operation can be performed at an appropriate timing as compared with the case of determining whether the fuel cell stack 10 is dried based on the temperature of the fuel cell stack 10. Therefore, the dry-wet state of the fuel cell stack 10 can accurately be detected, and the performance of the system can be improved.
(1) Specifically, control apparatus 100 determines whether the fuel cell stack 10 deviates from the ideal dry-wet state based on impedance imp of the fuel cell stack 10. According to this, the drying of the fuel cell stack 10 can accurately be detected.
(2) The control apparatus 100 determines whether the fuel cell stack 10 deviates from the ideal dry-wet state based on the impedance imp at a specific place in the plane of the single cell C. The drying of the fuel cell stack 10 tends to occur at a specific place in the plane of the single cell C. For this reason, it is desirable to determine whether the fuel cell stack 10 is dried based on the impedance imp at a specific place, rather than the entire area, in the plane of the single cell C.
(3) The high-temperature and high-load condition being the operating condition of the reset operation is a condition that is established when the current flowing through the fuel cell stack 10 becomes equal to or higher than a reference current and when the temperature of the fuel cell stack 10 becomes equal to or higher than a reference temperature. When the high-temperature and high-load condition is established, the control apparatus 100 determines whether the fuel cell stack 10 deviates from the ideal dry-wet state based on the change amount of the impedance imp. According to this, the drying of the fuel cell stack 10 can accurately be detected under the condition under which the fuel cell stack 10 is likely to be dried.
(4) The reset operation is an operation for reducing the air stoichiometric ratio and increasing the air pressure. As described above, the drying of the fuel cell stack 10 can be sufficiently suppressed by lowering the air stoichiometric ratio or increasing the air pressure during the reset operation.
(5) Specifically, the reset operation is a gradual change operation in which the air stoichiometric ratio and the air pressure are continuously changed. As described above, by continuously changing the air stoichiometric ratio or the air pressure, it is possible to suppress the power fluctuation and the influence on drivability associated with the reset operation.
(6) After performing the reset operation, the reset operation and the normal operation before performing the reset operation are alternately repeated. Since the effect of the reset operation may not be permanent, it is desirable to operate the fuel cell stack 10 at a comprehensively good output point in the system by alternately switching the reset operation and the normal operation. In addition, by alternately performing the reset operation and the normal operation, it is possible to prevent the fuel cell stack 10 from being maintained in the excessively wet state by the reset operation. Here, when the electrolyte membrane is brought close to the excessively wet state from the dry state in which the electrolyte membrane is dried by the reset operation, a period from when the reset operation is switched to the normal operation to when the electrolyte membrane is brought into the dry state can be made longer than when the state is changed from the dry state to an appropriate wet state by the reset operation. Therefore, it is desirable that the reset operation is an operation in which the inside of the fuel cell stack 10 is brought close to the excessively wet state from the dry state in which the inside of the fuel cell stack 10 is dried.
(7) After performing the reset operation for recovering the dry-wet state of the fuel cell stack 10, when the recovery condition under which the dry-wet state of the fuel cell stack 10 is estimated to be recovered is established, the control apparatus 100 switches from the reset operation to the normal operation performed before performing the reset operation. Accordingly, the fuel cell stack 10 can be operated at a comprehensively good output point in the system.
(8) Specifically, the recovery condition is a condition that is established when the impedance imp during the reset operation becomes equal to or less than the initial value. As described above, the state of the fuel cell stack 10 can be recovered to the state when the high-temperature and high-load condition is established by the reset operation. As the recovery condition, for example, a condition that is established when the impedance imp or the like at the time of performing the reset operation reaches a predetermined threshold value can be considered, but in this case, it is not possible to cope with variations due to individual differences of parts or the like. Therefore, the recovery condition is desirably a condition that is established when the physical quantity during the reset operation becomes equal to or less than the initial value.

### Second Embodiment

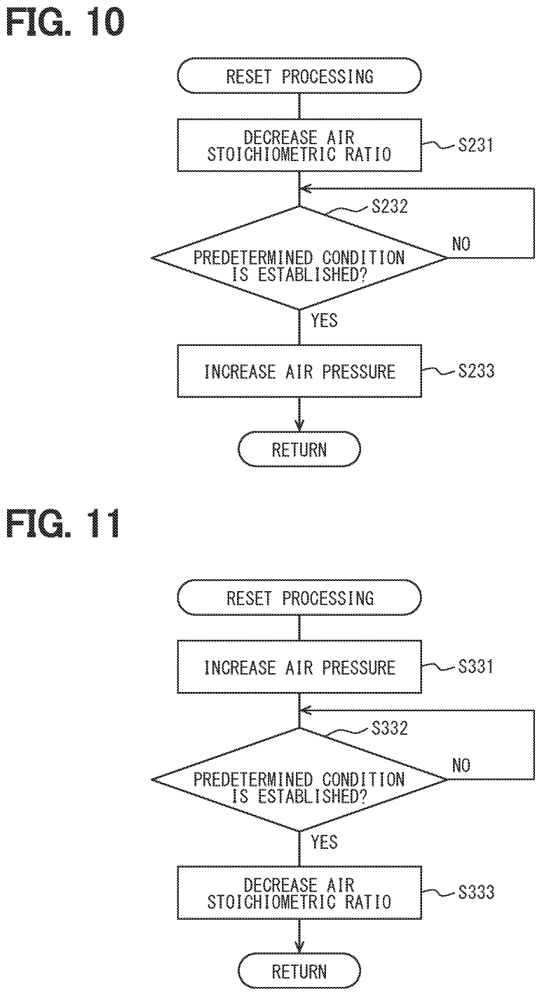

Next, a second embodiment will be described with reference to FIG. 10. In the present embodiment, different portions from those of the first embodiment will be mainly described.

FIG. 10 shows a flow of reset processing executed by the control apparatus 100 of the present embodiment. The reset processing shown in FIG. 10 is processing corresponding to the reset processing in FIG. 5 described in the first embodiment. The reset processing shown in FIG. 10 is started when the fuel cell stack 10 deviates from the ideal dry-wet state.

As shown in FIG. 10, the control apparatus 100 decreases the air stoichiometric ratio in step S231. The control apparatus 100 continuously decreases the air stoichiometric ratio. The reset operation is a gradual change operation in which the air stoichiometric ratio is gradually changed.

Subsequently, in step S232, the control apparatus 100 determines whether a predetermined condition is established. This predetermined condition is preferably, for example, a condition that is established when a predetermined time has elapsed since the start of the decrease in the air stoichiometric ratio, or a condition that is established when the air stoichiometric ratio reaches an intended value.

The control apparatus 100 waits until the predetermined condition is established, and when the predetermined condition is established, the control apparatus 100 proceeds to step S233 and increases the air pressure. The control apparatus 100 continuously increases the air pressure. The reset operation is a gradual change operation in which the air pressure is gradually changed.

The rest is the same as that of the first embodiment. The fuel cell system 1 of the present embodiment can obtain an effect produced from a configuration common to or configuration equivalent to that of the first embodiment as in the first embodiment.
(1) The reset operation of the present embodiment is an operation of increasing the air pressure when a predetermined condition is established after the air stoichiometric ratio is decreased. As described above, by lowering the air stoichiometric ratio first, it is possible to suppress an increase, associated with an increase in air pressure, in energy consumption in an auxiliary machine such as the air pump 32 or an increase in a thermal load of the air pump 32 or the like. Such a reset operation is effective when power of the fuel cell stack 10 and auxiliary machines such as the air pump 32 has no margin, and it is desirable to reduce a load first, or when a decrease in output of the fuel cell stack 10 can be compensated for by a battery or the like. The decrease in output of the fuel cell stack 10 is not preferable because it causes torque shock of the traveling motor or the like.

### Modification of Second Embodiment

The control apparatus 100 of the second embodiment waits until a predetermined condition is established, and increases the air pressure when the predetermined condition is established, but the processing is not essential. For example, the control apparatus 100 may increase the air pressure when only lowering the air stoichiometric ratio is not sufficient for the recovery effect of drying of the fuel cell stack 10. In this case, the predetermined condition is preferably, for example, a condition that is established when the impedance imp of the fuel cell stack 10 does not become equal to or less than the initial value even when a predetermined time elapses after the air stoichiometric ratio decreases.

### Third Embodiment

Next, a third embodiment will be described with reference to FIG. 11. In the present embodiment, different portions from those of the first embodiment will be mainly described.

FIG. 11 shows a flow of reset processing executed by the control apparatus 100 of the present embodiment. The reset processing shown in FIG. 11 is processing corresponding to the reset processing in FIG. 5 described in the first embodiment. The reset processing shown in FIG. 11 is started when the fuel cell stack 10 deviates from the ideal dry-wet state.

As shown in FIG. 11, the control apparatus 100 increases the air pressure in step S331. The control apparatus 100 continuously increases the air pressure. The reset operation is a gradual change operation in which the air pressure is gradually changed.

Subsequently, in step S332, the control apparatus 100 determines whether a predetermined condition is established. This predetermined condition is preferably, for example, a condition that is established when a predetermined time has elapsed since the start of the increase in the air pressure, or a condition that is established when the air pressure reaches an intended value.

The control apparatus 100 waits until the predetermined condition is established, and when the predetermined condition is established, the control apparatus 100 proceeds to step S333 and decreases the air stoichiometric ratio. The control apparatus 100 continuously lowers the air stoichiometric ratio. The reset operation is a gradual change operation in which the air stoichiometric ratio is gradually changed.

The rest is the same as that of the first embodiment. The fuel cell system 1 of the present embodiment can obtain an effect produced from a configuration common to or configuration equivalent to that of the first embodiment as in the first embodiment.
(1) The reset operation of the present embodiment is an operation of lowering the air stoichiometric ratio when a predetermined condition is established after the air pressure is increased. As described above, by increasing the air pressure first, it is possible to suppress a decrease in the output of the fuel cell stack 10 associated with a decrease in the air stoichiometric ratio. Such a reset operation is effective when there is a margin in power of the fuel cell stack 10 and auxiliary machines such as the air pump 32, and the fuel cell stack 10 can withstand a temporary decrease in output and increase in heat quantity.

### Modification of Third Embodiment

The control apparatus 100 of the third embodiment waits until a predetermined condition is established, and decreases the air stoichiometric ratio when the predetermined condition is established, but the processing is not essential. For example, the control apparatus 100 may decrease the air stoichiometric ratio when only increasing the air pressure is not sufficient for the recovery effect of drying of the fuel cell stack 10. In this case, the predetermined condition is preferably, for example, a condition that is established when the impedance imp of the fuel cell stack 10 does not become equal to or less than the initial value even when a predetermined time elapses after the air stoichiometric ratio decreases.

### Fourth Embodiment

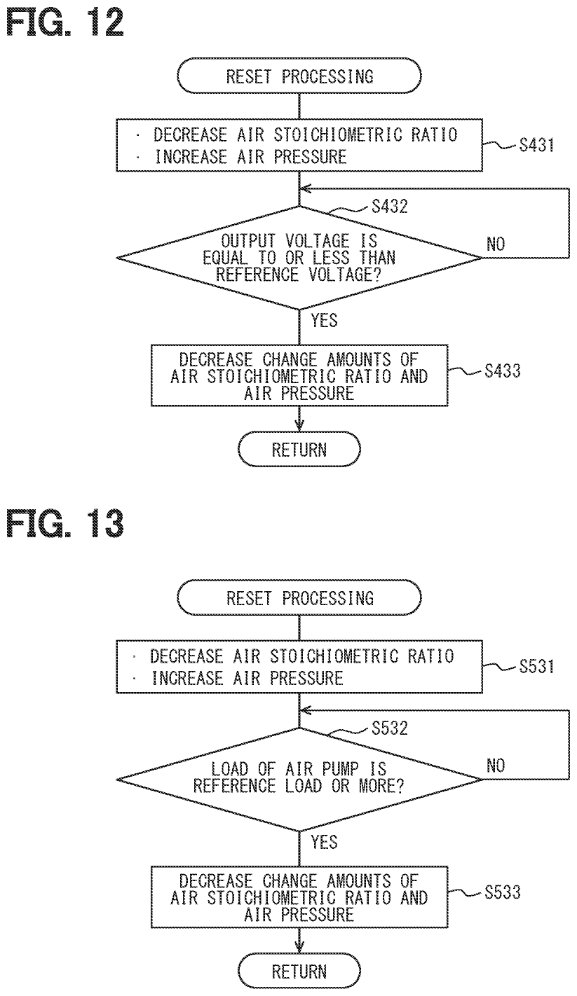

Next, a fourth embodiment will be described with reference to FIG. 12. In the present embodiment, different portions from those of the first embodiment will be mainly described.

When the reset operation is performed, the output voltage of fuel cell stack may decrease. Therefore, the control apparatus 100 of the present embodiment controls the change amount of the air stoichiometric ratio and the air pressure based on the output voltage of the fuel cell stack 10 so as to suppress the decrease in the output voltage of the fuel cell stack 10 during the reset operation. Hereinafter, the reset processing executed by the control apparatus 100 of the present embodiment will be described with reference to FIG. 12. The reset processing shown in FIG. 12 is processing corresponding to the reset processing in FIG. 5 described in the first embodiment. The reset processing shown in FIG. 12 is started when the fuel cell stack deviates from the ideal dry-wet state.

As shown in FIG. 12, the control apparatus 100 decreases the air stoichiometric ratio and increases the air pressure in step S431. Since the processing is similar to the processing in step S131 in FIG. 5 described in the first embodiment, the description thereof will be omitted.

Subsequently, in step S432, the control apparatus 100 determines whether the output voltage of the fuel cell stack 10 is equal to or less than a predetermined reference voltage. The reference voltage may be a predetermined fixed voltage, or may be, for example, a value obtained by subtracting a predetermined value from the output voltage when the high-temperature and high-load condition is established.

When the output voltage of the fuel cell stack 10 exceeds the predetermined reference voltage, the control apparatus 100 skips the subsequent processing and exits the reset processing. On the other hand, when the output voltage of the fuel cell stack 10 becomes the predetermined reference voltage or less, the control apparatus 100 proceeds to step S433.

In step S433, the control apparatus 100 reduces the change amounts of the air stoichiometric ratio and the air pressure. Specifically, the control apparatus 100 sets the change amounts of the air stoichiometric ratio and the air pressure to zero so as to suppress the decrease in the output voltage of the fuel cell stack 10. As long as the decrease in the output voltage of the fuel cell stack 10 is suppressed, the control apparatus 100 may slightly increase the air stoichiometric ratio or slightly decrease the change in the air pressure.

The rest is the same as that of the first embodiment. The fuel cell system 1 of the present embodiment can obtain an effect produced from a configuration common to or configuration equivalent to that of the first embodiment as in the first embodiment.
(1) In the reset operation of the present embodiment, the change amounts of the air stoichiometric ratio and the air pressure are controlled based on the output voltage of the fuel cell stack 10 so that the decrease in the output voltage of the fuel cell stack 10 is suppressed. According to this, it is possible to recover drying of the fuel cell stack 10 while suppressing fluctuation of the output voltage of the fuel cell stack 10.

### Modification of Fourth Embodiment

In the reset operation of the fourth embodiment, the change amounts of the air stoichiometric ratio and the air pressure are controlled based on the output voltage of the fuel cell stack 10, but the present disclosure is not limited thereto. In the reset operation, for example, a change amount of one of the air stoichiometric ratio and the air pressure may be controlled based on the output voltage of the fuel cell stack 10.

### Fifth Embodiment

Next, a fifth embodiment will be described with reference to FIG. 13. In the present embodiment, different portions from those of the first embodiment will be mainly described.

When the reset operation is performed, the load of the air pump 32 may increase due to an increase in the air pressure. Therefore, the control apparatus 100 of the present embodiment controls the change amounts of the air stoichiometric ratio and the air pressure based on the load of the air pump 32 so as to suppress an increase in the load of the air pump 32 during the reset operation. Hereinafter, the reset processing executed by the control apparatus 100 of the present embodiment will be described with reference to FIG. 13. The reset processing shown in FIG. 13 is processing corresponding to the reset processing in FIG. 5 described in the first embodiment. The reset processing shown in FIG. 13 is started when the fuel cell stack 10 deviates from the ideal dry-wet state.

As shown in FIG. 13, the control apparatus 100 decreases the air stoichiometric ratio and increases the air pressure in step S531. Since the processing is similar to the processing in step S131 in FIG. 5 described in the first embodiment, the description thereof will be omitted.

Subsequently, in step S532, the control apparatus 100 determines whether the load of the air pump 32 is a predetermined reference load or more. The reference load may be a predetermined fixed load, or may be, for example, a value obtained by adding a predetermined value to the load when the high-temperature and high-load condition is established.

When the load of the air pump 32 is less than the predetermined reference load, the control apparatus 100 skips the subsequent processing and exits the reset processing. On the other hand, when the load of the air pump 32 becomes the predetermined reference load or more, the control apparatus 100 proceeds to step S533.

In step S533, the control apparatus 100 reduces the change amounts of the air stoichiometric ratio and the air pressure. Specifically, the control apparatus 100 sets the change amounts of the air stoichiometric ratio and the air pressure to zero so as to suppress the increase in the load of the air pump 32. As long as the increase in the load of the air pump 32 is suppressed, the control apparatus 100 may slightly increase the air stoichiometric ratio or slightly decrease the change in the air pressure.

The rest is the same as that of the first embodiment. The fuel cell system 1 of the present embodiment can obtain an effect produced from a configuration common to or configuration equivalent to that of the first embodiment as in the first embodiment.
(1) In the reset operation, the change amounts of the air stoichiometric ratio and the air pressure are controlled based on the load of the air pump 32 so as to suppress an increase in the load of the air pump 32. According to this, it is possible to recover drying of the fuel cell stack 10 while suppressing increase in the load of the air pump 32.

### Modification of Fifth Embodiment

In the reset operation of the fifth embodiment, the change amounts of the air stoichiometric ratio and the air pressure are controlled based on the load of the air pump 32, but the present disclosure is not limited thereto. In the reset operation, for example, a change amount of one of the air stoichiometric ratio and the air pressure may be controlled based on the load of the air pump 32.

### Sixth Embodiment

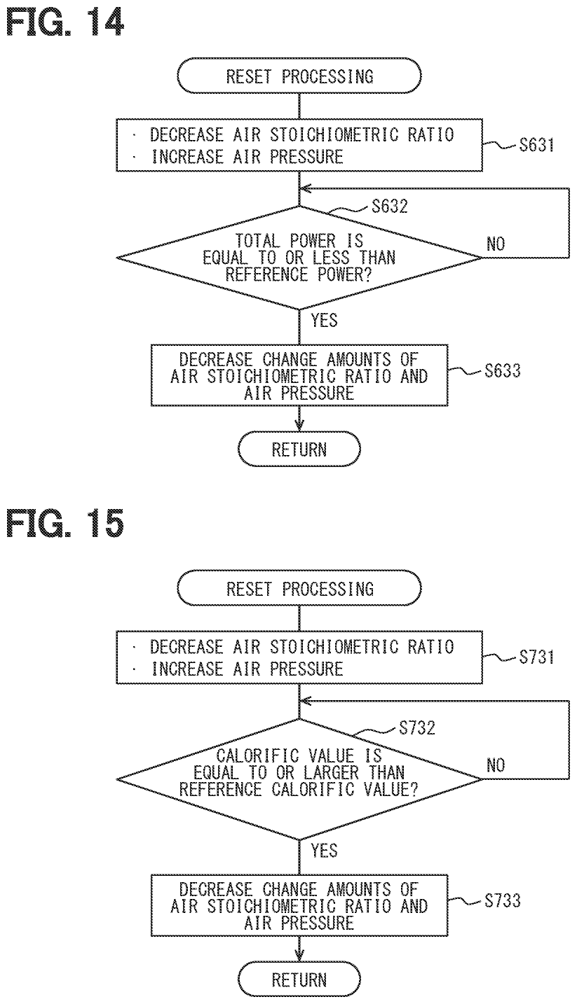

Next, a sixth embodiment will be described with reference to FIG. 14. In the present embodiment, different portions from those of the first embodiment will be mainly described.

When the reset operation is performed, the total power obtained by excluding the power consumption consumed by the operation of the fuel cell stack 10 from the generated power of the fuel cell stack 10 may decrease. Therefore, the control apparatus 100 of the present embodiment controls the change amounts of the air stoichiometric ratio and the air pressure based on the total power so as to suppress the decrease in the total power during the reset operation. Hereinafter, the reset processing executed by the control apparatus 100 of the present embodiment will be described with reference to FIG. 14. The reset processing shown in FIG. 14 is processing corresponding to the reset processing in FIG. 5 described in the first embodiment. The reset processing shown in FIG. 14 is started when the fuel cell stack 10 deviates from the ideal dry-wet state.

As shown in FIG. 14, the control apparatus 100 decreases the air stoichiometric ratio and increases the air pressure in step S631. Since the processing is similar to the processing in step S131 in FIG. 5 described in the first embodiment, the description thereof will be omitted.

Subsequently, in step S632, the control apparatus 100 determines whether the total power of the fuel cell system 1 is equal to or less than predetermined reference power. The reference power may be a predetermined fixed load, or may be, for example, a value obtained by subtracting a predetermined value from the load when the high-temperature and high-load condition is established.

When the total power of the fuel cell system 1 exceeds the reference power, the control apparatus 100 skips the subsequent processing and exits the reset processing. On the other hand, when the total power of the fuel cell system 1 is equal to or less than the reference power, the control apparatus 100 proceeds to step S633.

In step S633, the control apparatus 100 reduces the change amounts of the air stoichiometric ratio and the air pressure. Specifically, the control apparatus 100 sets the change amounts of the air stoichiometric ratio and the air pressure to zero so as to suppress the decrease in the total power of the fuel cell system 1. As long as the decrease in the total power of the fuel cell system 1 is suppressed, the control apparatus 100 may slightly increase the air stoichiometric ratio or slightly decrease the change in the air pressure.

The rest is the same as that of the first embodiment. The fuel cell system 1 of the present embodiment can obtain an effect produced from a configuration common to or configuration equivalent to that of the first embodiment as in the first embodiment.
(1) In the reset operation, the change amounts of the air stoichiometric ratio and the air pressure are controlled based on the total power of the fuel cell stack 10 so that the decrease in the total power of the fuel cell system 1 is suppressed. According to this, it is possible to recover drying of the fuel cell stack 10 while suppressing decrease in the total power of the fuel cell system 1.

### Modification of Sixth Embodiment

In the reset operation of the sixth embodiment, the change amounts of the air stoichiometric ratio and the air pressure are controlled based on the total power of the fuel cell system 1, but the present disclosure is not limited thereto. In the reset operation, for example, a change amount of one of the air stoichiometric ratio and the air pressure may be controlled based on the total power of the fuel cell system 1.

### Seventh Embodiment

Next, a seventh embodiment will be described with reference to FIG. 15. In the present embodiment, different portions from those of the first embodiment will be mainly described.

When the reset operation is performed, a calorific value generated by the operation of the fuel cell stack 10 may increase. The calorific value generated by the operation of fuel cell stack 10 includes a calorific value in an auxiliary machine such as the air pump 32 in addition to the calorific value of the fuel cell stack 10.

Therefore, the control apparatus 100 of the present embodiment controls the change amounts of the air stoichiometric ratio and the air pressure based on the calorific value so as to suppress an increase in the calorific value generated by the operation of the fuel cell stack 10 during the reset operation. Hereinafter, the reset processing executed by the control apparatus 100 of the present embodiment will be described with reference to FIG. 15. The reset processing shown in FIG. 15 is processing corresponding to the reset processing in FIG. 5 described in the first embodiment. The reset processing shown in FIG. 15 is started when the fuel cell stack deviates from the ideal dry-wet state.

As shown in FIG. 15, the control apparatus 100 decreases the air stoichiometric ratio and increases the air pressure in step S731. Since the processing is similar to the processing in step S131 in FIG. 5 described in the first embodiment, the description thereof will be omitted.

Subsequently, in step S732, the control apparatus 100 determines whether the calorific value of the fuel cell system 1 is equal to or larger than the predetermined reference calorific value. The reference calorific value may be a predetermined fixed load, or may be, for example, a value obtained by adding a predetermined value to the calorific value when the high-temperature and high-load condition is established.

When the calorific value of the fuel cell system 1 is less than the reference calorific value, the control apparatus 100 skips the subsequent processing and exits the reset processing. On the other hand, when the calorific value of the fuel cell system 1 is equal to or larger than the reference calorific value, the control apparatus 100 proceeds to step S733.

In step S733, the control apparatus 100 reduces the change amounts of the air stoichiometric ratio and the air pressure. Specifically, the control apparatus 100 sets the change amounts of the air stoichiometric ratio and the air pressure to zero so as to suppress the increase in the calorific value of the fuel cell system 1. As long as the increase in the calorific value of the fuel cell system 1 is suppressed, the control apparatus 100 may slightly increase the air stoichiometric ratio or slightly decrease the change in the air pressure.

The rest is the same as that of the first embodiment. The fuel cell system 1 of the present embodiment can obtain an effect produced from a configuration common to or configuration equivalent to that of the first embodiment as in the first embodiment.
(1) In the reset operation, the change amounts of the air stoichiometric ratio and the air pressure are controlled based on the calorific value of the fuel cell system 1 so that the increase in the calorific value of the fuel cell system 1 is suppressed. According to this, it is possible to recover drying of the fuel cell stack 10 while suppressing increase in the calorific value of the fuel cell system 1.

### Modification of Seventh Embodiment

In the reset operation of the seventh embodiment, the change amounts of the air stoichiometric ratio and the air pressure are controlled based on the calorific value of the fuel cell system 1, but the present disclosure is not limited thereto. In the reset operation, for example, a change amount of one of the air stoichiometric ratio and the air pressure may be controlled based on the calorific value of the fuel cell system 1.

### Eighth Embodiment

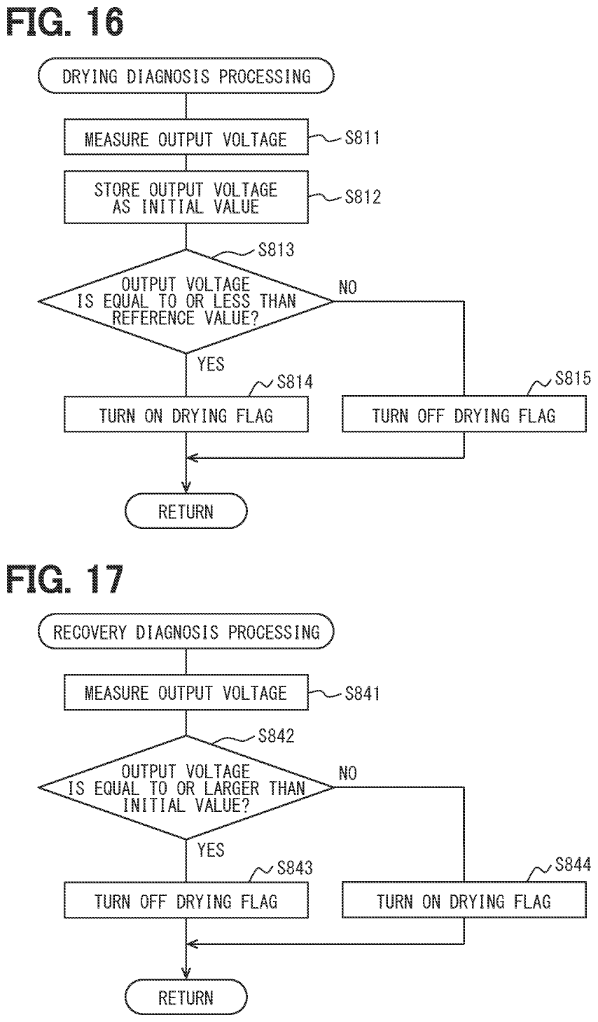

Next, an eighth embodiment will be described with reference to FIGS. 16 and 17. In the present embodiment, different portions from those of the first embodiment will be mainly described.

As described in the first embodiment, the output voltage of the fuel cell stack is a physical quantity having a higher correlation with drying and wetting of the fuel cell stack 10 than the temperature of the fuel cell stack 10. Therefore, in the drying diagnosis processing and the recovery diagnosis processing of the present embodiment, based on the change amount of the output voltage of the fuel cell stack it is determined whether the fuel cell stack 10 is in the deviation state of deviating from the ideal drying state or whether it is recovered from the deviation state drying.

First, the drying diagnosis processing executed by the control apparatus 100 will be described with reference to the flowchart in FIG. 16. The drying diagnosis processing shown in FIG. 16 is processing corresponding to the drying diagnosis processing in FIG. 4 described in the first embodiment. The dry diagnosis processing shown in FIG. 16 is started when the high-temperature and high-load condition is established.

As shown in FIG. 16, the control apparatus 100 measures the output voltage of the fuel cell stack 10 in step S811. Specifically, the control apparatus 100 acquires the output voltage of fuel cell stack 10 from the FC voltage detection unit 105.

Subsequently, in step S812, the control apparatus 100 stores the output voltage when the high-temperature and high-load condition is first established after the start of the fuel cell stack 10 in the memory as an initial value. The initial value may be a fixed value, but may be learned and updated based on the output voltage when the high-temperature and high-load condition is established in the next and subsequent times. For example, the initial value may be an average value of the output voltages when the high-temperature and high-load condition is established.

Subsequently, the control apparatus 100 determines whether the fuel cell stack 10 is in the deviation state of deviating from the ideal dry-wet state. Specifically, in step S813, the control apparatus 100 determines whether the output voltage of the fuel cell stack 10 is equal to or less than a reference value. The reference value is set to, for example, an output voltage actually measured in a state where the fuel cell stack 10 is dried or an output voltage in a state where the water content inside the fuel cell stack 10 is equal to or less than a predetermined value.

When the output voltage of the fuel cell stack 10 is equal to or less than the reference value, it is estimated that the fuel cell stack 10 is dried. Therefore, the control apparatus 100 determines that the fuel cell stack 10 is in the deviation state of deviating from the ideal dry-wet state. Specifically, the control apparatus 100 turns on the drying flag in step S814. The drying flag is a flag indicating a dry-wet state of the fuel cell stack 10, and is turned on by the control apparatus 100 when the drying of the fuel cell stack 10 is detected.

On the other hand, when the output voltage of the fuel cell stack 10 is less than the reference value, it is estimated that the fuel cell stack 10 is dried. Therefore, the control apparatus 100 turns off the drying flag in step S815.

Next, the recovery diagnosis processing executed by the control apparatus 100 will be described with reference to the flowchart in FIG. 17. The recovery diagnosis processing shown in FIG. 17 is processing corresponding to the recovery diagnosis processing in FIG. 6 described in the first embodiment. The recovery diagnosis processing shown in FIG. 17 is started after the reset processing is performed.

As shown in FIG. 17, the control apparatus 100 measures the output voltage of the fuel cell stack 10 in step S841. Since the processing is processing similar to that in step S811 in FIG. 16, the description thereof will be omitted.

Subsequently, in step S842, the control apparatus 100 determines whether the output voltage of the fuel cell stack 10 is equal to or larger than an initial value. The initial value is the output voltage of the fuel cell stack 10 when the high-temperature and high-load condition is established.

When the output voltage of the fuel cell stack 10 is equal to or larger than the initial value, the output voltage of the fuel cell stack 10 recovers to that at the time when the high-temperature and high-load condition is established, and it is estimated that the drying of the fuel cell stack 10 is sufficiently recovered by the reset processing. Therefore, when the output voltage of fuel cell stack 10 is equal to or larger than the initial value, the control apparatus 100 turns off the drying flag in step S843.

On the other hand, when the output voltage of the fuel cell stack 10 exceeds the initial value, it is estimated that the fuel cell stack 10 is still dried. Therefore, the control apparatus 100 keeps the drying flag on in step S844.

The rest is the same as that of the first embodiment. The fuel cell system 1 of the present embodiment can obtain an effect produced from a configuration common to or configuration equivalent to that of the first embodiment as in the first embodiment.
(1) The control apparatus 100 of the present embodiment determines whether the fuel cell stack 10 deviates from the ideal dry-wet state based on the output voltage of the fuel cell stack 10. According to this, the drying of the fuel cell stack 10 can accurately be detected.
(2) The control apparatus 100 of the present embodiment determines whether the fuel cell stack 10 deviates from the ideal dry-wet state based on the output voltage of the fuel cell stack 10. According to this, the recovery of the fuel cell stack can accurately be detected.

### Modification of Eighth Embodiment

The control apparatus 100 of the eighth embodiment performs the drying diagnosis processing and the recovery diagnosis processing based on the output voltage of the fuel cell stack 10, but the present disclosure is not limited thereto. For example, the control apparatus 100 may respectively perform the drying diagnosis processing and the recovery diagnosis processing based on the impedance imp of the fuel cell stack 10 and the output voltage of the fuel cell stack 10.

### Other Embodiments

Although the representative embodiments of the present disclosure have been described above, the present disclosure is not limited to the above-described embodiments, and can be variously modified as follows, for example.

The drying diagnosis processing or the recovery diagnosis processing of the above-described embodiments is performed based on the impedance imp of the fuel cell stack 10 or the output voltage of the fuel cell stack 10, but in addition to these, may be performed with reference to other physical quantities such as the temperature of the cooling water immediately after passing through the fuel cell stack 10. The temperature of the cooling water immediately after passing through the fuel cell stack is a physical quantity having correlation with drying and wetting of the fuel cell stack 10. For example, the control apparatus 100 may determine whether the fuel cell stack is excessively wet based on the impedance imp of the fuel cell stack 10 or the output voltage of the fuel cell stack 10.

As in the above-described embodiments, it is desirable that in the impedance detection unit 107, the distribution of the impedance imp in the plane of the single cell C is graspable, but the present disclosure is not limited thereto, and the impedance imp in the entire plane of the single cell C may be graspable.

The high-temperature and high-load condition of the above-described embodiments is a condition that is established according to the current flowing through the fuel cell stack 10 and the temperature of the fuel cell stack 10, but the present disclosure is not limited thereto. The high-temperature and high-load condition may be, for example, a condition that is established according to the power required from the load apparatus 12 or the temperature of the cooling water.

In the reset operation of the above-described embodiments, the air stoichiometric ratio is decreased and the air pressure is increased, but the present disclosure is not limited thereto. When the humidifier is installed in the fuel cell system 1, the reset operation may be processing of increasing the humidification amount in the humidifier.

In the fuel cell system 1 of the above embodiments, the reset operation and the normal operation are repeated after the reset operation is performed, but the present disclosure is not limited thereto, and for example, the reset operation may be continued.

In the fuel cell system 1 of the above embodiments, after the reset operation is performed, when the impedance imp or the output voltage returns to the value when the high-temperature and high-load condition is established, the operation is switched from the reset operation to the normal operation, but the present disclosure is not limited thereto. For example, the fuel cell system 1 may switch from the reset operation to the normal operation after a predetermined time elapses after performing the reset operation.

In the above-described embodiments, an example in which the fuel cell system 1 of the present disclosure is applied to the vehicle FCV has been described, but the fuel cell system 1 of the present disclosure can also be applied to other than the vehicle FCV.

In the above-described embodiments, it is needless to say that the elements constituting the embodiments are not necessarily essential unless otherwise explicitly specified as particularly essential, unless otherwise considered as apparently essential in principle, or the like.

In the above-described embodiments, when a numerical value such as the number, a numerical value, an amount, or a range of the components of the embodiment is mentioned, the numerical value is not limited to a specific number unless otherwise particularly explicitly specified as being essential, unless otherwise apparently limited to the specific number in principle, or the like.

In the above-described embodiments, when the shapes, positional relationships, and the like of the components and the like are mentioned, the shapes, positional relationships, and the like are not limited thereto unless otherwise explicitly specified, unless otherwise limited to specific shapes, positional relationships, and the like in principle, or the like.

The control unit and the method thereof of the present disclosure may be implemented by a dedicated computer provided by configuring a processor and a memory programmed to execute one or more functions embodied by a computer program. The control unit and the method thereof of the present disclosure may be implemented by a dedicated computer provided by configuring a processor by one or more dedicated hardware logic circuits. The control unit and the method thereof of the present disclosure may be implemented by one or more dedicated computers configured by a combination of a processor and a memory programmed to execute one or more functions and a processor configured by one or more hardware logic circuits. In addition, the computer program may be stored in a computer-readable non-transitory tangible storage medium as an instruction executed by a computer.

What is claimed is:

1. A fuel cell system comprising:
a fuel cell stack including a plurality of single cells being stacked;
a dry-wet detection unit configured to detect a dry-wet state of the fuel cell stack; and
an operation control unit configured to control an operation of the fuel cell stack, wherein
the dry-wet detection unit is configured to, when an operating condition in which the fuel cell stack is at a high temperature and at a high load is established, determine whether the fuel cell stack is in a deviation state, which deviates from an ideal dry-wet state, based on a physical quantity, wherein the physical quantity has a higher correlation with drying and wetting of the fuel cell stack than a temperature of the fuel cell stack, and
the operation control unit is configured to
perform, on detection of the deviation state, a reset operation to recover the dry-wet state,
subsequently, continue the reset operation, until a recovery condition, which is for determining whether the dry-wet state of the fuel cell stack is recovered, is established, wherein
the operating condition is established when a current, which flows through the fuel cell stack, is equal to or higher than a reference current and when a temperature of the fuel cell stack is equal to or higher than a reference temperature, and
the dry-wet detection unit is configured to
store, in a memory, the physical quantity when the operating condition is established and
determine whether the recovery condition is established based on a change amount of the physical quantity with respect to the physical quantity stored in the memory.

2. The fuel cell system according to claim 1, wherein
the physical quantity includes at least one of a voltage of the fuel cell stack or an impedance of the fuel cell stack.

3. The fuel cell system according to claim 1, wherein
the dry-wet detection unit is configured to determine whether the deviation state is established based on the physical quantity at a specific place in a plane of the single cell.

4. The fuel cell system according to claim 1, wherein
a ratio of an amount of oxidant gas, which is supplied to the fuel cell stack, to an amount of oxidant gas, which is theoretically required for power generation by the fuel cell stack, is an air stoichiometric ratio,
a pressure of oxidant gas inside the fuel cell stack is an air pressure, and
the reset operation is to perform at least one of a decrease in the air stoichiometric ratio or an increase in the air pressure.

5. The fuel cell system according to claim 4, wherein
the reset operation is to decrease the air stoichiometric ratio when a predetermined condition is established after the air pressure is increased.

6. The fuel cell system according to claim 4, wherein
the reset operation is to increase the air pressure when a predetermined condition is established after the air stoichiometric ratio is decreased.

7. The fuel cell system according to claim 4, wherein
the reset operation is a gradual change operation to continuously change at least one of the air stoichiometric ratio or the air pressure.

8. The fuel cell system according to claim 4, wherein
in the reset operation, a change amount of at least one of the air stoichiometric ratio or the air pressure is controlled based on an output voltage of the fuel cell stack, such that a decrease in the output voltage is suppressed.

9. The fuel cell system according to claim 4, further comprising:
an oxidant gas supply unit configured to supply oxidant gas to the fuel cell stack, wherein
in the reset operation, a change amount of at least one of the air stoichiometric ratio or the air pressure is controlled based on a load of the oxidant gas supply unit, such that an increase in the load of the oxidant gas supply unit is suppressed.

10. The fuel cell system according to claim 4, further comprising:
an oxidant gas supply unit configured to supply oxidant gas to the fuel cell stack, wherein
in the reset operation, a change amount of at least one of the air stoichiometric ratio or the air pressure is controlled based on a total power or a calorific value, such that a decrease in the total power or an increase in the calorific value is suppressed, wherein
the total power is obtained by excluding a power consumption consumed by the operation of the fuel cell stack from a generated power of the fuel cell stack, and
the increase in the calorific value is caused by the operation of the fuel cell stack.

11. The fuel cell system according to claim 1, wherein
the operation control unit is configured to, after performing the reset operation, alternately repeat the reset operation and a normal operation, which has been performed before the reset operation.

12. The fuel cell system according to claim 1, wherein
the operation control unit is configured to, after performing the reset operation, switch from the reset operation to a normal operation, which has been performed before the reset operation, when the recovery condition is established.

13. The fuel cell system according to claim 12, wherein
the physical quantity, when the operating condition is established, is an initial value, and
the recovery condition is established when the physical quantity in the reset operation becomes equal to or less than the initial value.

14. A fuel cell system comprising:
a fuel cell stack including a plurality of single cells being stacked; and
a processor configured to
detect a dry-wet state of the fuel cell stack,
control an operation of the fuel cell stack,
determine, when an operating condition in which the fuel cell stack is at a high temperature and at a high load is established, whether the fuel cell stack is in a deviation state, which deviates from an ideal dry-wet state, based on a physical quantity,
wherein the physical quantity has a higher correlation with drying and wetting of the fuel cell stack than a temperature of the fuel cell stack,
wherein the operating condition is established when a current, which flows through the fuel cell stack, is equal to or higher than a reference current and when a temperature of the fuel cell stack is equal to or higher than a reference temperature,
perform, on detection of the deviation state, a reset operation to recover the dry-wet state,
subsequently, continue the reset operation, until a recovery condition, which is for determining whether the dry-wet state of the fuel cell stack is recovered, is established,
store, in a memory, the physical quantity when the operating condition is established, and
determine whether the recovery condition is established based on a change amount of the physical quantity with respect to the physical quantity stored in the memory.
